(19) United States
(12) Patent Application Publication
(10) Pub. No.: US 2004/0022192 A1
(43) Pub. Date: Feb. 5, 2004

(54) Bit stream processor

(76) Inventor: Raheel Ahmed Khan, Tustin, CA (US)

Correspondence Address: RAHEEL KHAN, 4590 MACARTHUR BLVD, # 500, NEWPORT BEACH, CA, 92660, US

(21) Appl. No.: 10/211,852

(22) Filed: Aug. 5, 2002

(51) Int. Cl. H04J 1/16; H04L 12/28

(52) U.S. Cl. 370/235; 370/392

(57) ABSTRACT

The Bit Stream Processor provides a unified scheme to separate any protocol stack into a Packet Path (PP) and a Protocol Control (PC) process. The Protocol Control process contains the control functions that are loosely coupled with the packet processing. The Packet Path process contains not only the data-processing functions, but also all the tightly coupled control processing functions that are not included in the PC process. By separating each layer of the protocol stack into PP and PC processes, the control and packet path for the entire communication stack can be implemented separately. The PP can be implemented in hardware whereas the PC can be implemented in software running on a microprocessor. Since the processing is separated this results in system level cost saving. The overall scheme offers flexibility comparable to software based approaches and efficiency comparable to hard-wired solutions.

### CROSS REFERENCE TO RELATED APPLICATION

I claim the benefit of the filing date of PPA 60/308,400 and 60/308,402 on Jul. 30, 2001.

### FEDERALLY SPONSORED RESEARCH

Not Applicable

### SEQUENCE LISTING OR PROGRAM

Not Applicable

### BACKGROUND—FIELD OF INVENTION

### Communication Protocol Processing

This invention relates to a low power processor that provides an efficient and highly optimized architecture to process communication protocols. It has the following additional features: scalable, configurable, low latency, and high throughput.

### BACKGROUND—DESCRIPTION OF PRIOR ART

Many communication protocols span several layers of the OSI model. Conventional implementation approach of such protocols is to have a separate resource to handle the processing of each layer. This usually results in a highly complex and power inefficient system.

All wireless communication protocols are based on data packets that traverse a communication medium. Processing such a packet usually involves bit intensive operations that differ from one protocol to another, but yet all fall in one class of operations. When high throughput and low power are both requirement for processing packets, hard-wired solutions are usually sought. It is highly desirable to have a configurable, low power device that is optimized for packet processing.

Therefore, there exists a need for eliminating the costly internetworking infrastructure and the risks of using hard-wired solutions. The Bit Stream Processor (BSP) is designed to be such a device.

### SUMMARY OF INVENTION

This invention provides Protocol Control and Packet Processing separation across protocol layers. Additionally, it provides a scalable architecture that uses configurable bit processing elements while maintaining the efficiency of hard-wired solutions.

### DRAWINGS

### Drawing Figures

The construction designed to carry out the invention will hereinafter be described, together with other features thereof.

The invention will be more readily understood from a reading of the following specification and by reference to the accompanying drawings forming a part thereof, wherein an example of the invention is shown, and wherein:

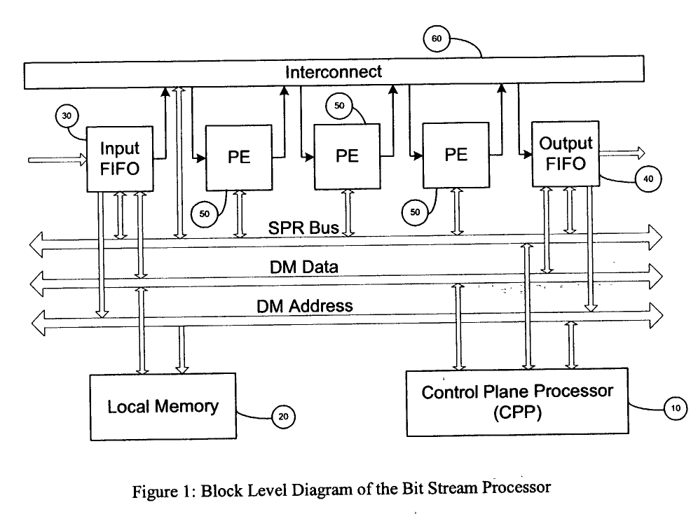

FIG. 1 is a block level diagram of the Bit Stream Processor (BSP)

### REFERENCE NUMERALS IN DRAWINGS

10 Control Plane Processor (CPP)

20 Local Memory

30 Input FIFO (IFIFO)

40 Output FIFO (OFIFO)

50 Processing Element

60 Interconnect

### DETAILED DESCRIPTION

The Bit Stream Processor processing path provides elemental bit processing in hardware and low level protocol control processing in firmware.

The BSP core as shown in FIG. 1 is comprised of a Control Plane Processor (CPP) 10 and various interconnected processing elements 50. The major components are:

Control Plain Processor 10

Input FIFO (IFIFO) 30

Output FIFO (OFIFO) 40

Processing Elements (PE) 50

Interconnect 60

The BSP has separate control and data paths. Data packets enter on a parallel bus connected to the input FIFO 30. The output from this FIFO is a serial data stream that is passed through processing elements, which are interconnected by a flexible (programmable) interconnect. After processing is complete, the serial data is output on a parallel bus. Control communications paths are provided between the Control Plane Processor (CPP) 10 and other BSP units. The CPP 10 also configures and controls the processing elements in the data path.

The CPP 10 uses a Harvard architecture in which program memory and data memory are separate, and hence, instructions and data are accessed on separate buses. A 16-bit wide program memory bus fetches instructions from the program memory while an internal 32-bit wide data bus fetches data from the Register File. Furthermore, three external 32-bit wide data buses fetch data from data memory, co-processor registers and message FIFO's. The CPP executes instructions through a six-stage pipeline. Hence, each instruction takes one cycle to execute with the exception of branch instructions.

IFIFO 30 as shown in FIG. 1 is an intelligent processing element, which serves as a regular FIFO and at the same time performs parallel-to-serial bit conversion. Internal depth of IFIFO 30 is 8 bytes, divided into two 4-byte buffers. This depth can be extended to a defined space in the BSP local data memory by configuring the IFIFO 30 with the Start Address and the End Address of this memory space. The IFIFO 30 uses this memory space as a circular buffer. Up to two memory spaces (Bank 0 & Bank 1) can be specified. A BANK select bit is used to select the Bank to be used by the IFIFO 30. The memory space is only used when internal 8-byte buffer is full.

OFIFO 40 as shown in FIG. 1 is an intelligent processing element, which serves as regular FIFO and at the same time performs serial-to parallel bit conversion. Internal depth of the OFIFO is 8 bytes, divided into two 4-byte buffers. This depth can be extended to a defined space in the BSP local data memory by configuring the OFIFO 40 with the Start Address and the End Address of this memory space. The OFIFO 40 uses this memory space as a circular buffer. Up to two memory spaces (Bank 0 & Bank 1) can be specified. A BANK select bit is used to select the Bank to be used by the OFIFO 40. The memory space is only used when internal 8-byte buffer is full.

Input data to the BSP is always through the IFIFO 30 while data out of the BSP always goes through the OFIFO 40. In-between the data may be manipulated by other processing elements connected between the IFIFO 30 and OFIFO 40. Data flows serially (bit level) out of IFIFO 30 through other processing element and finally flows serially into the OFIFO 40.

Processing elements 50 can be added as needed per processing function required. Examples include FIFO's (Input, Output, Source, Sink), CRC, Timers, Control and Status Registers, etc.

The Interconnect 60 as shown in FIG. 1 is used to connect different processing elements together by configuring its internal registers. A total of 256 processing elements can be interconnected. The output of one processing element can be the input to several processing elements. However, each processing element can have only one input. Each processing element has a designated register in the interconnect that specifies the input to that processing element. The Interconnect 60 has 64 registers. Each register is 32 bits wide and can be used to interconnect up to 4 processing elements, and hence, 256 processing elements can be interconnected.

We claim:

1. A method for separating control and data path for any communication protocol.

2. A method for accessing the data flow at any time so that bit operations can be performed.

3. Configurable bit processing elements that can be interconnected under control of a processor to perform different functions.
